(19) United States
(12) Patent Application Publication
(10) Pub. No.: US 2024/0392829 A1
(43) Pub. Date: Nov. 28, 2024

(54) SYSTEMS FOR HINGE RECEIVERS IN COOKING APPLIANCES

(71) Applicant: Haier US Appliance Solutions, Inc., Wilmington, DE (US)

(72) Inventor: Caleb Farrel, Jeffersonville, IN (US)

(21) Appl. No.: 18/323,739

(22) Filed: May 25, 2023

(51) Int. Cl. E05D 5/02; B23P 19/04; F16C 11/04

(52) U.S. Cl. CPC F16C 11/04; B23P 19/04; E05Y 2900/304; E05Y 2900/308; E05Y 2900/31; E05Y 2900/312; F24C 15/023

(57) ABSTRACT

An appliance includes a frame defining an interior within the frame, a user interface, and a door providing selective access to the interior. The door includes a hinge, and a hinge receiver coupled to the frame of the appliance. The hinge receiver includes a first fastener hole disposed on an outward face of the hinge receiver, and a first fastener extending through the first fastener hole into the frame. The hinge receiver also includes a locating hole positioned on the outward face of the hinge receiver, a locating projection extending from the frame into the locating hole, and a second fastener hole disposed on an outward face of the hinge receiver with a second fastener extending through the second fastener hole into the frame.

### FIELD OF THE INVENTION

The present subject matter relates generally to systems for hinge receivers in range appliances, particularly locating hinge receivers in range appliances.

### BACKGROUND OF THE INVENTION

Range appliances generally include heating elements for heating cooking utensils, such as pots, pans, and griddles, as well as an oven for baking and broiling. A user can select a desired heating level, and operation of one or more of the heating elements or oven is modified to match the selected heating level. For example, certain range appliances include electric heating elements. During operation, the range appliance operates the electric heating elements at a predetermined power output corresponding to a selected heating level. As another example, some range appliances include gas burners as heating elements.

Traditionally, doors mounted to the oven portion of the range appliance couple via hinges and hinge receivers on the front frame, and the hinge receivers are aligned and assembled using screws. This process introduces a lot of variation into assembly process when trying to control appearance gaps, part alignment for assembly, etc. Also having screws to hold the part requires operator to either hold/support the hinge or receiver while driving the screws or have a fixture which supports the respective components. Depending on the set up, these options can be difficult to use or can create manufacturing concerns.

### BRIEF DESCRIPTION OF THE INVENTION

Aspects and advantages of the invention will be set forth in part in the following description, or may be apparent from the description, or may be learned through practice of the invention.

In one example embodiment, an appliance includes a frame defining an interior within the frame, a user interface, and a door providing selective access to the interior. The door includes a hinge, and a hinge receiver coupled to the frame of the appliance. The hinge receiver includes a first fastener hole disposed on an outward face of the hinge receiver, and a first fastener extending through the first fastener hole into the frame. The hinge receiver also includes a locating hole positioned on the outward face of the hinge receiver, a locating projection extending from the frame into the locating hole, and a second fastener hole disposed on an outward face of the hinge receiver with a second fastener extending through the second fastener hole into the frame.

In another example embodiment, a method of assembling a hinge receiver of an appliance. The method includes aligning a first locating hole of a hinge receiver with a first locating hole of the frame of the appliance such that a locating projection extends through the first locating hole of the hinge receiver and the first locating hole of the frame along a locating axis, and rotating the hinge receiver about the locating axis in order to align a first fastener hole and a second fastener hole of the hinge receiver with the frame of the appliance. The method also includes fastening the hinge receiver to the frame of the appliance with a first fastener extending through the first fastener hole into the frame and a second fastener extending through the second fastener hole into the frame.

In another example embodiment, an alternative method of assembling a hinge receiver of an appliance. The method includes aligning a locating hole of a hinge receiver with a locating projection of the frame of the appliance such that the locating projection extends through the locating hole of the hinge receiver along a locating axis, and rotating the hinge receiver about the locating axis in order to align a first fastener hole and a second fastener hole of the hinge receiver with the frame of the appliance. The method also includes fastening the hinge receiver to the frame of the appliance with a first fastener extending through the first fastener hole into the frame and a second fastener extending through the second fastener hole into the frame.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front, perspective view of a range appliance according to an example embodiment of the present disclosure.

FIG. 2 provides a top view of the example range appliance of FIG. 1.

FIG. 3 provides a side section view of the example range appliance of FIG. 1.

FIG. 4 provides a perspective view of a hinge receiver according to an example embodiment of the present disclosure.

FIG. 5 provides a perspective view of the hinge receiver of FIG. 4.

FIG. 6 provides a perspective view of the hinge receiver of FIG. 4, according to another alternative embodiment of the present disclosure.

FIG. 7 provides an example method of assembling according to aspects of the present disclosure.

FIG. 8 provides an alterative example method of assembling according to aspects of the present disclosure.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “upstream” and “downstream” refer to the relative flow direction with respect to fluid flow in a fluid pathway. For example, “upstream” refers to the flow direction from which the fluid flows, and “downstream” refers to the flow direction to which the fluid flows. The terms “includes” and “including” are intended to be inclusive in a manner similar to the term “comprising.” Similarly, the term “or” is generally intended to be inclusive (i.e., “A or B” is intended to mean “A or B or both”).

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a ten percent (10%) margin.

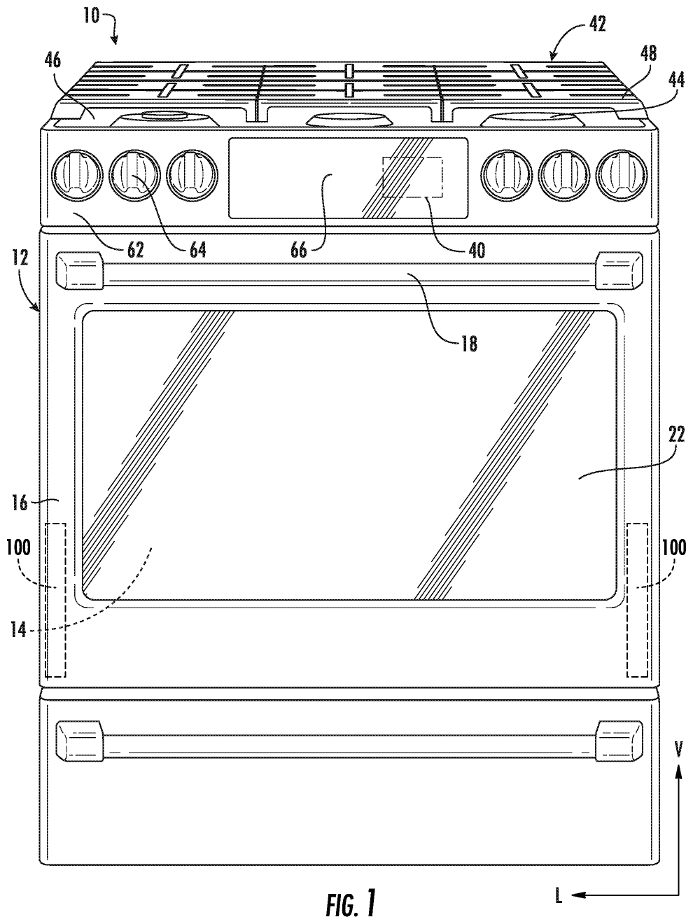

Referring now to the figures, FIG. 1 is a front view of a cooking appliance, such as an range appliance 10, according to an example embodiment of the present disclosure. Generally, the range appliance 10 defines a vertical direction V, a lateral direction L, and a transverse direction T. The vertical direction V, lateral direction L, and transverse direction T are mutually perpendicular and form an orthogonal direction system. As will be understood, the range appliance 10 is provided by way of example only, and the present subject matter may be used in any suitable appliance. It should be appreciated that the subject matter of the present disclosure may be applicable to any suitable appliance with rotating door(s). Thus, aspects of the present disclosure may be used with other refrigerator appliance, microwave appliance, range appliance, oven appliance, dishwasher appliance, washing machine appliance, and dryer appliance configurations (e.g., configurations that define multiple interior cavities for the receipt of food, include no interior cavities, or are otherwise different than the configuration shown in FIG. 1), as would be understood in light of the present disclosure.

The range appliance 10 includes an insulated cabinet 12 with an interior cooking chamber 14 defined by an interior surface of cabinet 12. The cooking chamber 14 is configured for the receipt of one or more food items to be cooked. The range appliance 10 includes a door 16 rotatably mounted to cabinet 12 (e.g., with a hinge—not shown). A handle 18 may be mounted to door 16 and may assist a user with opening and closing door 16 in order to access an opening to cooking chamber 14. For example, a user can pull on the handle 18 to open or close door 16 and access cooking chamber 14 through the opening. As would be understood, one or more internal heating elements (e.g., baking or broiling heating elements) may be provided within cooking chamber 14 to cook or otherwise heat items therein.

Further, the range appliance 10 can include a seal (not shown) between the door 16 and the cabinet 12 that assist with maintaining heat and cooking fumes within cooking chamber 14 when the door 16 is in a closed position, as shown in FIG. 1. One or more parallel glass panes 22 provide for viewing the contents of cooking chamber 14 when door 16 is closed and assist with insulating cooking chamber 14. Optionally, a baking rack (not pictured) is positioned in cooking chamber 14 for the receipt of food items or utensils containing food items.

Moreover, the range appliance 10 may include a cooktop surface 42 having one or more heating elements 44 for use in heating or cooking operations. In exemplary embodiments. the cooktop surface 42 is comprised of a metal (e.g., steel) panel 46 on which one or more grates 48, described in further detail below, may be supported. In other embodiments, however, the cooktop surface 42 may be constructed of another suitable material, such as a ceramic glass or another suitable non-metallic material. In alternative embodiments, the range appliance 10 may be a wall oven without the cooktop surface 42.

Further, the heating elements 44 may be various sizes, as shown in FIG. 1, and may employ any suitable method for heating or cooking an object, such as a cooking utensil (not shown), and its contents. In one embodiment, for example, the heating element(s) 44 may use a heat transfer method, such as electric coils or gas burners, to heat the cooking utensil. In another embodiment, however, the heating element(s) 44 uses an induction heating method to heat the cooking utensil directly. In turn, heating element may include a burner element, electric heat clement, induction element, or another suitable heating element.

Some embodiments of the range appliance 10 may further include a controller 40, e.g., configured to control one or more operations of range appliance 10. For example, the controller 40 may control at least one operation of the range appliance 10 that includes an internal heating element or cooktop heating element 44 and/or the door 16. As such, the controller 40 may be in communication (e.g., via a suitable wired or wireless connection) with one or more of heating element(s) 44, as well as any other suitable components of the range appliance 10, as discussed herein. In general, the controller 40 may be operable to configure the range appliance 10 (and various components thereof) for cooking. Such configuration may be based, for instance, on a plurality of cooking factors of a selected operating cycle or mode.

By way of example, the controller 40 may include one or more memory devices and one or more microprocessors, such as general or special purpose microprocessors operable to execute programming instructions or micro-control code associated with an operating cycle. The memory may represent random access memory such as DRAM, or read only memory such as ROM or FLASH. In one embodiment, the processor executes programming instructions stored in memory. The memory may be a separate component from the processor or may be included onboard within the processor.

In an embodiment, the controller 40 may be positioned in a variety of locations throughout the range appliance 10. As illustrated, the controller 40 may be located within a user interface 62 of the range appliance 10. In some such embodiments, input/output (“I/O”) signals may be routed between the controller 40 and various operational components of the range appliance 10, such as the door 16, the heating element(s) 44, control knobs 100, display component 66, sensors, alarms, or other components as may be provided. For instance, signals may be directed along one or more wiring harnesses that may be routed through cabinet 12. In some embodiments, the controller 40 is in communication with the user interface assembly 62 and the control knobs 100 through which a user may select various operational features and modes and monitor progress of the range appliance 10. In one embodiment, the user interface 62 may represent a general purpose I/O (“GPIO”) device or functional block. In another embodiment, the user interface 62 may include input components, such as one or more of a variety of electrical, mechanical, or electro-mechanical input devices including rotary dials, push buttons, and touch pads. Further, the user interface 62 may include a display component 66, such as a digital or analog display configured to provide operational feedback to a user.

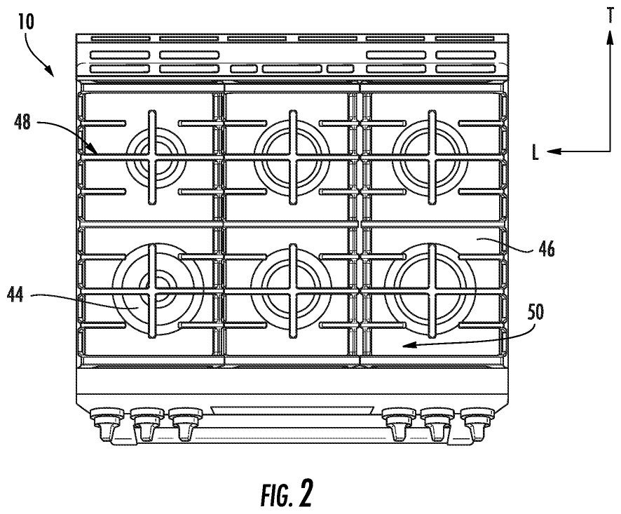

Referring now to FIG. 2, a top view of the range appliance 10 of FIG. 1 is illustrated. As described above, the cooktop surface 42 may include a plurality of heating elements 44 and a panel 46. The panel 46 may be concave (e.g., downward along the vertical direction V) to form a depression or cavity 50 therein. Thus, the heating element(s) 44 may be provided within the cavity 50 and cooking grates 48 may be positioned over top of the heating element(s) 44 (e.g., along the vertical direction V). In this example, the cooktop surface 42 includes six heating elements 44. It should be noted that the disclosure is not limited to this, and the cooktop surface 42 may include fewer or more heating elements 44 as specific applications dictate. In some embodiments, one or more heating elements 44 may be located proximate an edge of panel 46, as will be described in more detail below.

In addition, as shown, the cooktop surface 42 may include one or more cooking grates 48 provided over the heating elements 44. As shown in FIG. 2, for example, the cooktop surface 42 may include three cooking grates 48. It should be noted that the disclosure is not limited to this, and the cooktop surface 42 may include fewer or more cooking grates 48 as specific applications dictate. Each cooking grate 48 may extend from a rear of panel 46 to a front of the panel 46 along the transverse direction. Additionally, or alternatively, the cooking grates 48 may be positioned adjacent to each other along the lateral direction L.

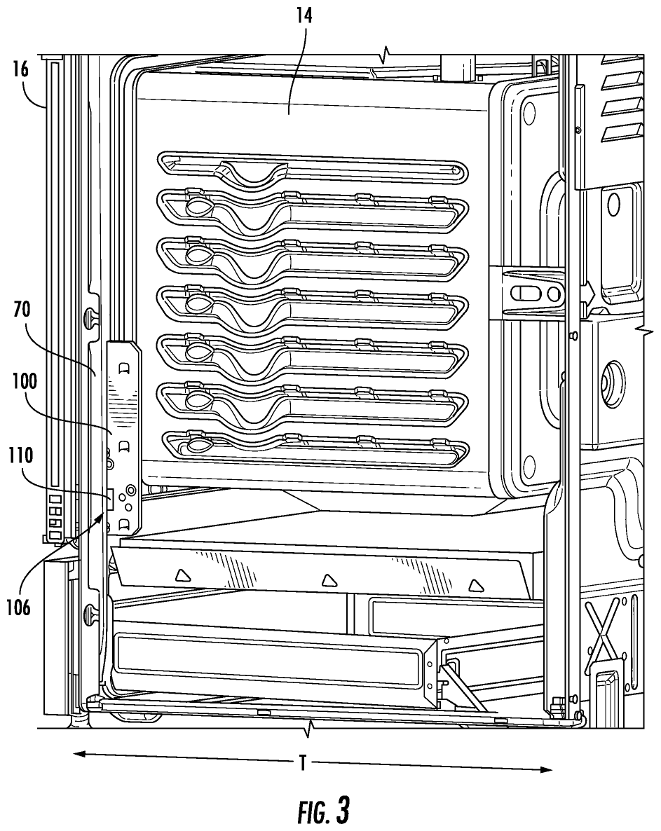

Referring now to FIG. 3, shown is a side perspective view of the example range appliance of FIG. 1. In general, a hinge receiver 100 may be mounted to a frame 70 of the range appliance 10. Generally, hinge receiver 100 may be one of a pair of hinge receivers 100 disposed on opposing sides of frame 70 relative to the width of the door to the cooking chamber 14, as generally seen in FIG. 1. Hinge receiver 100 may be generally configured for receiving a hinge 110 of door 16. In general, a slot 106 in hinge receiver 100 may be configured to receive hinge 110.

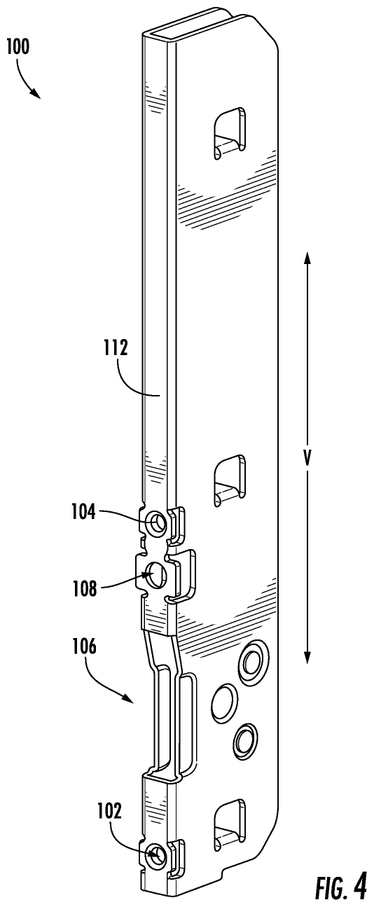

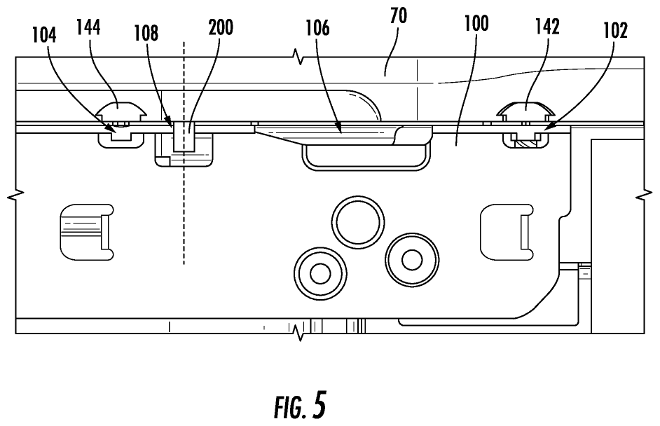

Particularly, as may be seen in FIG. 4, hinge receiver 100 may include a first fastener hole 102, a second fastener hole 104, slot 106, and a locating hole 108. In general, first fastener hole 102 and second fastener hole 104 may be disposed on an outward face 112 of hinge receiver 100. Additionally, slot 106 and locating hole 108 may also be positioned on outward face 112 of the hinge receiver 100. Specifically, both the locating hole 108 and the slot 106 may be positioned between the first fastener hole 102 and the second fastener hole 104. Generally, hinge receiver 100 may be fastened into position based upon the positioning of locating hole 108. For example, locating hole 108 may be used to accurately set the vertical and lateral position of hinge receiver 100. Specifically, fasteners, e.g., a first fastener 142 (FIG. 5) and a second fastener 144 (FIG. 5), may be inserted in each of first fastener hole 102 and second fastener hole 104 in order to secure hinge receiver 100 to frame 70. For example, first fastener 142 and second fastener 144 may be a screw or bolt.

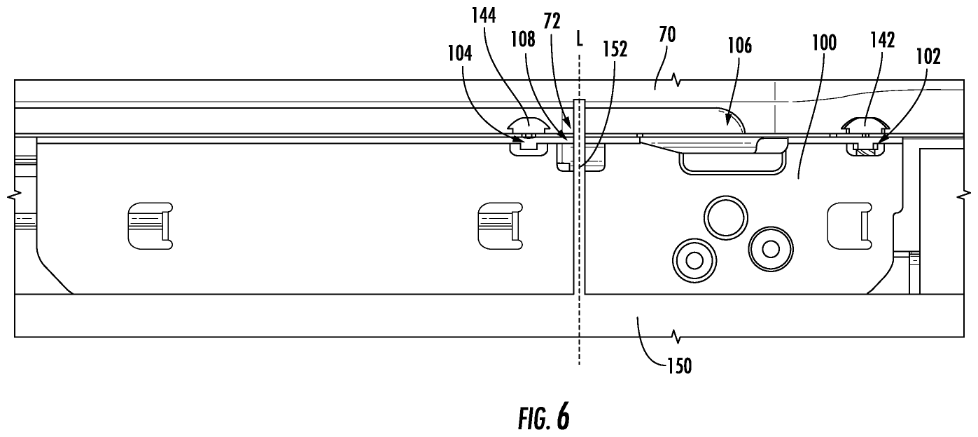

In general, as may be seen in FIG. 5 locating hole 108 of hinge receiver 100 may be utilized in combination with a locating projection 200 on frame 70 or a locating projection 152 (FIG. 6) of a assembly fixture 150 (FIG. 6) used to align the hinge receiver 100 to frame 70. Specifically, in the example embodiment seen in FIG. 5, frame 70 may include a locating projection 200 engaging with the locating hole 108 of the hinge receiver 100. In general, locating projection 200 extends through the first locating hole 108 of the hinge receiver 100 along a locating axis L. The locating projection 200 may engage with the locating hole 108 in order to aid aligning the first fastener hole 102 and the second fastener hole 104 at the frame 70. Locating projection 200 may engage locating hole 108 of the hinge receiver 100, a cross-section of the locating projection 200 may be shaped complementary to locating hole 108 of the hinge receiver 100.

As seen in FIG. 6, in some embodiments, the locating hole 108 may interface with external fixturing, such as assembly fixture 150 generally configured for aiding assembly of the hinge receiver 100 to the frame 70. The external fixture may include a locating projection 152. In general, locating projection 152 extends through the first locating hole 108 of the hinge receiver 100 and a first locating hole 72 of frame 70 along a locating axis L. Locating projection 154 may engage first locating hole 108 of the hinge receiver 100 and first locating hole 72 of the frame 70, a cross-section of the locating projection 154 may be shaped complementary to first locating hole 108 of the hinge receiver 100 and first locating hole 72 of the frame 70. In order to align first fastener hole 102 and a second fastener hole 104 of the hinge receiver 100 with frame 70 of the appliance 10, hinge receiver 100 may be rotated about the locating axis L. When the hinge receiver 100 is aligned to the frame 70, first fastener 142 extending through the first fastener hole 102 into the frame 70 and second fastener 144 extending through the second fastener hole 104 into the frame 70 may fasten the hinge receiver to the frame of the appliance. While described in the context of range appliance 10, one of skill in the art would understand that aspects of the present disclosure may be applied to other suitable appliances. Additionally, one of skill in the art would understand that aspects of the present invention could be applied to a cavity mounted hinge receiver which mounts within the door as well.

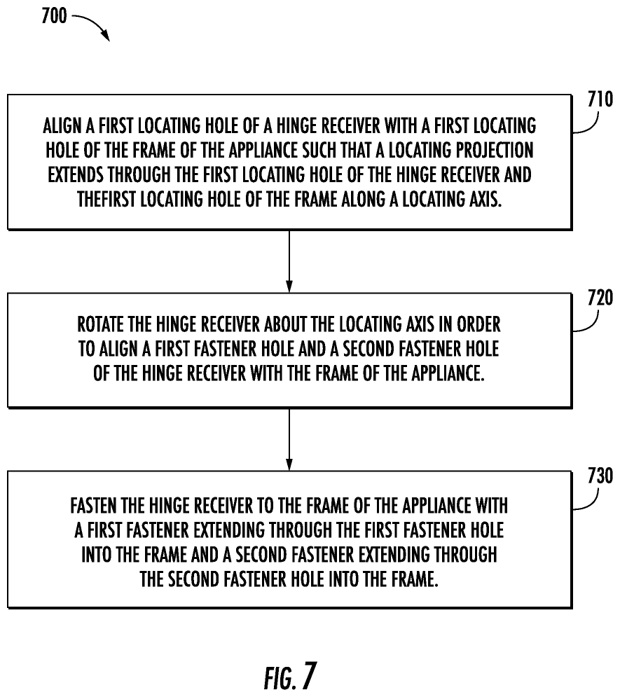

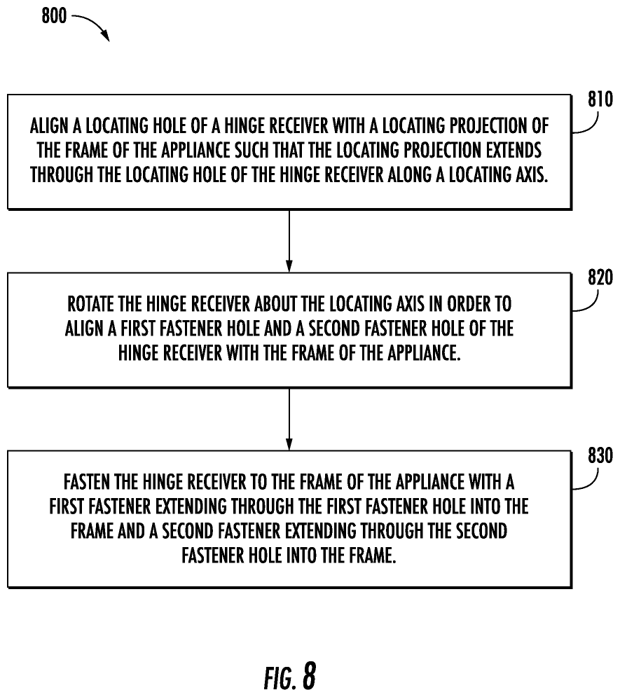

Referring now to FIGS. 7 and 8, a flow diagram of one embodiment of a method 700 of assembling a hinge receiver of an appliance and another embodiment of a method 800 of assembling a hinge receiver of an appliance. In general, the methods 700, 800 will be described herein with reference to the embodiments of the appliance 10 and hinge receiver 100 with reference to FIGS. 1-6. However, it should be appreciated by those of ordinary skill in the art that the disclosed methods 700, 800 may generally be utilized in association with apparatuses and systems having any other suitable configuration. In addition, although FIGS. 7 and 8 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 7, at (710), method 700 may generally include aligning first locating hole 108 of hinge receiver 100 with first locating hole 72 of the frame 70 of the appliance 10 such that locating projection 154 extends through first locating hole 108 of the hinge receiver 100 and the first locating hole 72 of the frame 70 along a locating axis L.

Additionally, at (720), method 700 may generally include rotating the hinge receiver 100 about the locating axis L in order to align first fastener hole 102 and a second fastener hole 104 of the hinge receiver 100 with the frame 70 of the appliance 10.

Moreover, at (730), method 700 may generally include fastening the hinge receiver 100 to the frame 70 of the appliance 10 with first fastener 142 extending through the first fastener hole 102 into the frame 70 and a second fastener 144 extending through the second fastener hole 104 into the frame 70.

As shown in FIG. 8, at (810), method 800 may generally include aligning locating hole 108 of hinge receiver 100 with locating projection 200 of the frame 70 of the appliance 10 such that the locating projection 200 extends through the locating hole 108 of the hinge receiver 100 along a locating axis L.

Additionally, at (820), method 800 may generally include rotating the hinge receiver 100 about the locating axis L in order to align first fastener hole 102 and a second fastener hole 104 of the hinge receiver 100 with the frame 70 of the appliance 10.

Moreover, at (830), method 800 may generally include fastening the hinge receiver 100 to the frame 70 of the appliance 10 with first fastener 142 extending through the first fastener hole 102 into the frame 70 and a second fastener 144 extending through the second fastener hole 104 into the frame 70.

As may be seen from the above, a hinge receiver includes a first fastener hole, a locating hole, a slot, and a second fastener hole disposed on an outward face of the hinge receiver. The first fastener hole is disposed above the second fastener hole, and both the locating hole and the slot are positioned between the first and second fastener hole. Fasteners in each of first fastener hole and second fastener hole may secure the hinge receiver to the frame, and the hinge receiver may be fastened into position based upon the positioning of locating hole.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An appliance, comprising:
a frame defining an interior within the frame;
a user interface;
a door providing selective access to the interior, the door comprising,
a hinge, and
a hinge receiver coupled to the frame of the appliance, the hinge receiver comprising,
a first fastener hole disposed on an outward face of the hinge receiver, a first fastener extending through the first fastener hole into the frame,
a locating hole positioned on the outward face of the hinge receiver, a locating projection extending from the frame into the locating hole, and
a second fastener hole disposed on an outward face of the hinge receiver, a second fastener extending through the second fastener hole into the frame.

2. The appliance of claim 1, wherein the locating projection engages the locating hole of the hinge receiver, a cross-section of the locating projection is shaped complementary to the locating hole of the hinge receiver.

3. The appliance of claim 1, wherein the hinge receiver is one of a pair of hinge receivers.

4. The appliance of claim 3, wherein the pair of hinge receivers are disposed on opposing sides of the frame of the appliance relative to a width of the door of the cooking chamber.

5. The appliance of claim 1, wherein the locating hole is positioned between the first fastener hole and the second fastener hole of the hinge receiver.

6. The appliance of claim 1, further comprising a slot positioned on the outward face of the hinge receiver, the hinge of the door received within the slot.

7. The appliance of claim 6, wherein the slot is positioned between the first fastener hole and second fastener hole.

8. The appliance of claim 1, wherein the appliance comprises at least one of a refrigerator appliance, microwave appliance, range appliance, oven appliance, dishwasher appliance, washing machine appliance, and dryer appliance.

9. A method of assembling a hinge receiver of an appliance, the method comprising:
aligning a first locating hole of a hinge receiver with a first locating hole of the frame of the appliance such that a locating projection extends through the first locating hole of the hinge receiver and the first locating hole of the frame along a locating axis;
rotating the hinge receiver about the locating axis in order to align a first fastener hole and a second fastener hole of the hinge receiver with the frame of the appliance; and
fastening the hinge receiver to the frame of the appliance with a first fastener extending through the first fastener hole into the frame and a second fastener extending through the second fastener hole into the frame.

10. The method of claim 9, wherein the locating projection engages the first locating hole of the hinge receiver and the first locating hole of the frame, a cross-section of the locating projection is shaped complementary to the first locating hole of the hinge receiver and the first locating hole of the frame.

11. The method of claim 9, wherein the locating first locating hole of the hinge receiver is positioned between the first fastener hole and the second fastener hole of the hinge receiver.

12. The method of claim 9, further comprising aligning a slot positioned on the outward face of the hinge receiver with a hinge positioned on a door of the appliance, the hinge of the door received within the slot.

13. The method of claim 12, wherein the slot is positioned between the first fastener hole and second fastener hole.

14. The method of claim 9, wherein the appliance comprises at least one of a refrigerator appliance, microwave appliance, range appliance, oven appliance, dishwasher appliance, washing machine appliance, and dryer appliance.

15. A method of assembling a hinge receiver of an appliance, the method comprising:
aligning a locating hole of a hinge receiver with a locating projection of the frame of the appliance such that the locating projection extends through the locating hole of the hinge receiver along a locating axis;
rotating the hinge receiver about the locating axis in order to align a first fastener hole and a second fastener hole of the hinge receiver with the frame of the appliance; and
fastening the hinge receiver to the frame of the appliance with a first fastener extending through the first fastener hole into the frame and a second fastener extending through the second fastener hole into the frame.

16. The method of claim 15, wherein the locating projection engages the locating hole of the hinge receiver, a cross-section of the locating projection is shaped complementary to the first locating hole of the hinge receiver.

17. The method of claim 15, wherein the locating hole of the hinge receiver is positioned between the first fastener hole and the second fastener hole of the hinge receiver.

18. The method of claim 15, further comprising aligning a slot positioned on the outward face of the hinge receiver with a hinge positioned on a door of the appliance, the hinge of the door received within the slot.

19. The method of claim 18, wherein the slot is positioned between the first fastener hole and second fastener hole.

20. The method of claim 15, wherein the appliance comprises at least one of a refrigerator appliance, microwave appliance, range appliance, oven appliance, dishwasher appliance. washing machine appliance, and dryer appliance.
